(19) United States
(12) Patent Application Publication
(10) Pub. No.: US 2017/0222326 A1
(43) Pub. Date: Aug. 3, 2017

(54) SLOTTED SLOT ANTENNA

(71) Applicants: Jim WIGHT, Ottawa (CA); Peter FRANK, Carp (CA); Roland SMITH, Nepean (CA); Mike SKOF, Nepean (CA); Telefonaktiebolaget LM Ericsson (publ), Stockholm (SE)

(72) Inventors: Jim WIGHT, Ottawa (CA); Peter FRANK, Carp (CA); Mike SKOF, Nepean (CA); Roland SMITH, Nepean (CA)

(73) Assignee: Telefonaktiebolaget LM Ericsson (publ), Stockholm (SE)

(21) Appl. No.: 15/327,593

(22) PCT Filed: Nov. 3, 2014
(86) PCT No.: PCT/IB2014/065773

§ 371 Date: Jan. 19, 2017

Related U.S. Application Data
(60) Provisional application No. 62/026,811, filed on Jul. 21, 2014.

(51) Int. Cl. H01Q 13/16; H01Q 9/04

(52) U.S. Cl. CPC H01Q 13/16; H01Q 9/0421; H01Q 1/48

(57) ABSTRACT

A slot antenna comprising a conductor, a principal slot, a feed point and one or more side slots is provided. The conductor has an axis defining a first conductor side and a second conductor side. The principal slot extends longitudinally within the conductor along the axis. The feed point comprises a first coupling point and a second coupling point respectively located on the first and second conductor sides. The one or more side slots extend from the principal slot. The slot antenna has a reduced physical length compared to the length of a typical slot antenna at the same frequency of operation. Electronic device comprising a ground plane and one or more slot antenna is provided. The one or more slot antennas are mounted on the ground plane.

### FIELD OF THE DISCLOSURE

The present invention relates to antennas and more particularly to slot antennas.

### BACKGROUND

Currently known low cost antennas include planar inverted “F” or “L” antennas (PIFA or PILA). The size of these antennas scales inversely with frequency, thus, at certain frequencies, such as 2.4 GHz used for Wi-Fi, PIFA and PILA antennas can be quite large.

Printed circuit board (PCB) antennas (including dipoles and monopoles) are also often used. However, they too scale inversely with frequency. Therefore, at certain frequencies, such as 2.4 GHz, they also can be quite large.

As radio products, including access points, reduce in size, the use of low cost bent metal PIFA and PILA antennas becomes a limiting factor affecting product dimensions. If PCB antennas are used, a small size requires high dielectric constant materials, increasing the overall cost of the product.

Typical slot antennas may be low cost, however, they can also be larger than it would be desirable for today's radio products.

A low cost small size antenna to overcome the problems of the prior art is therefore required.

### SUMMARY

Slot antennas that allow for a size reduction of the physical size of the antenna at a frequency of operation, compared to the physical size of a simple slot antenna at the same frequency of operation, are provided. Such antennas are referred herein as slotted slot antennas or toothed antennas.

According to a first embodiment, a slot antenna comprises a conductor, a principal slot, a feed point and one or more side slots. The conductor has an axis defining a first conductor side and a second conductor side. The principal slot extends longitudinally within the conductor along the axis. The feed point comprises a first coupling point and a second coupling point respectively located on the first and second conductor sides. The one or more side slots extend from the principal slot. The slot antenna has a reduced physical length compared to the length of a typical slot antenna at the same frequency of operation.

According to a second embodiment, an electronic device comprising a ground plane and a slot antenna according to the first embodiment is provided. The slot antenna is mounted on the ground plane.

According to a third embodiment and electronic device comprising a ground plane and a plurality of slot antennas according to the first embodiment is provided. The slot antennas are mounted on the ground plane.

Other embodiments of slotted slot antennas disclosed herein provide further size reductions while maintaining good gain and return loss. The slotted slot antenna is suitable for use in small form factor or ultra-compact Wi-Fi radios.

According to particular embodiments, the size of the antenna is further reduced, by folding the antenna along the side (or secondary) slots and/or along the principal slot.

According to particular embodiments, significant size reduction of the antenna, both in length and height (or width) may be achieved. The reduced size of the slotted slot antenna enables smaller radio products to be developed. The proposed antennas may also be tooled using tin as a low cost metal for the antenna.

According to particular embodiments, a slotted slot antenna includes one or more feed points to attach respective RF cables. According to other embodiments, a slotted slot antenna includes one or more feed points adapted to directly mount the antenna to a printed circuit board (PCB) without the use of intermediate RF cables.

The slotted slot antenna according to embodiments of the present disclosure may be realized as a vertically polarized or horizontally polarized antenna, and may therefore be used to provide polarization diversity, which is useful for Multiple Input Multiple Output (MIMO) operation.

Furthermore, an electronic device comprising one or more slotted slot antennas according to embodiments of the present disclosure may have a well-defined vertical polarization, which is useful for ceiling mounting. For example, an ultra-compact Wi-Fi radio may employ four slotted slot vertically polarized antennas, fed by RF cables.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIGS. 1A and 1B illustrate a prior art slot antenna and a prior art metal dipole antenna, respectively;

FIGS. 2A and 2B illustrate a prior art bent slot antenna and a prior art bent metal dipole antenna, respectively;

FIG. 3 illustrates a top view of a slot antenna according to an embodiment of the present disclosure;

FIGS. 4A, 4B, 5A, 5B, 6A, 6B, 7 and 8 illustrate slot antennas according to various embodiments of the present disclosure;

FIGS. 9A-9B illustrates dimensions of a slotted slot antenna according to an embodiment of the present disclosure;

FIG. 10 illustrates an electronic device comprising slotted slot antennas according to an embodiment of the present disclosure;

FIGS. 11A, 11B and 110 illustrate an electronic device comprising slotted slot antennas according to another embodiment of the present disclosure;

FIGS. 12-14 illustrate simulation results associated with the embodiment in FIGS. 11A-11C;

FIGS. 15 and 16 illustrate an electronic device comprising slotted slot antennas according to another embodiment of the present disclosure;

FIGS. 17, 18A, 18B and 19 illustrate simulation results associated with the embodiment in FIG. 11.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Typically, a metallic antenna comprises of an arrangement of conductors, electrically connected to the receiver or transmitter. An oscillating current of electrons forced through the antenna by a transmitter via a feed point creates an oscillating magnetic field around the antenna elements. At the same time, the charge of the electrons also creates an oscillating electric field along the elements. These time-varying fields radiate away from the antenna into space as a moving transverse electromagnetic field wave. Conversely, during reception, the oscillating electric and magnetic fields of an incoming radio wave exert force on the electrons in the antenna elements. This force causes the electrons to move back and forth, creating oscillating currents in the antenna, which are collected via a feed point. These currents are fed to a receiver to be amplified.

The present disclosure pertains to slot antennas. For ease of understanding, a typical slot antenna as known in the art will be referred herein as a simple slot antenna. Furthermore, while some of the description below is provided in reference to transmitting antennas, a person skilled in the art would readily understand the described concepts as applicable to receiving antennas.

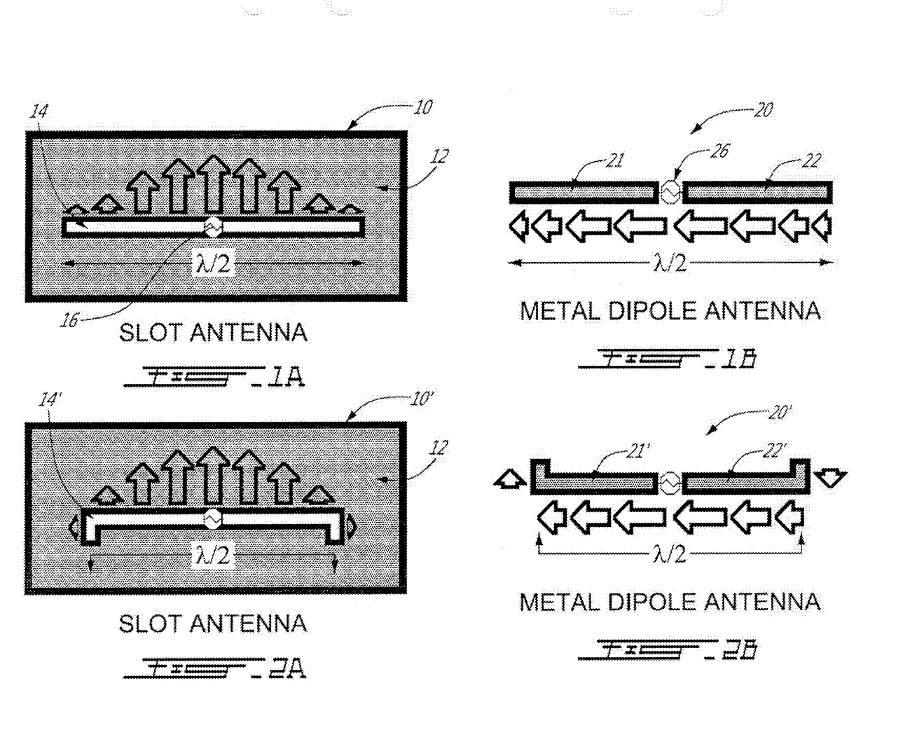

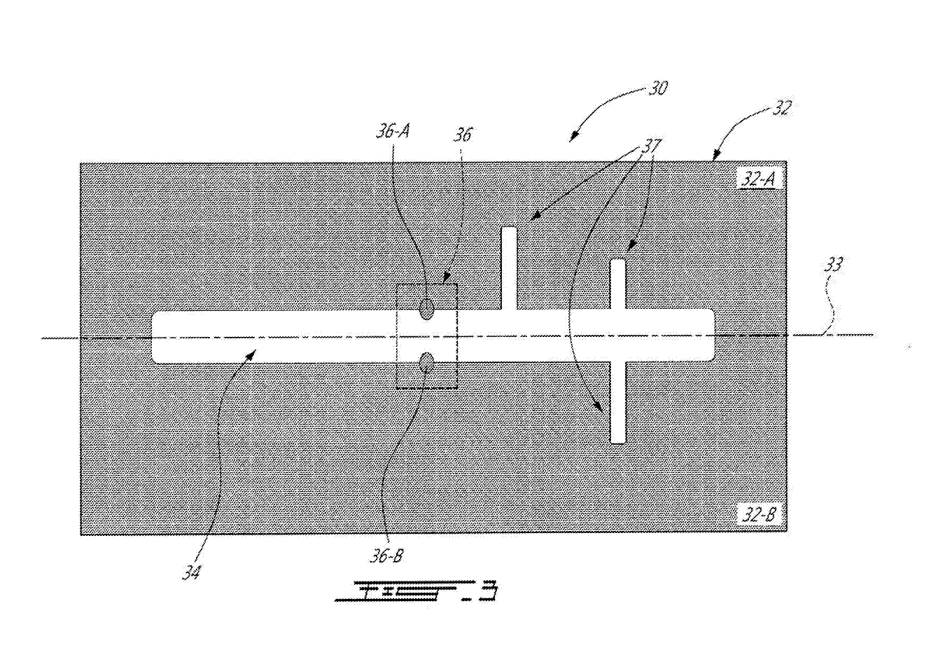

FIGS. 1A and 1B illustrate a prior art slot antenna 10 (referred herein as a ‘simple slot antenna’) and a prior art metal dipole antenna 20, respectively. The simple slot antenna 10 comprises a conductor 12, an elongated hole or slot 14 cut out within the conductor 12 and a feed point 16. Similarly, the metal dipole antenna 20 comprises two metal conductors 21, 22 of equal lengths and a feed point 26.

In operation, oscillating currents are respectively provided to the simple slot antenna 10 and metal dipole antenna 20 through feed points 16, 26. The means of resonance are different in the metal dipole antenna 20 compared to a simple slot antenna 10. In the case of the metal dipole antenna 20, the feed point 26 is between the metal conductors 21, 22 and the electromagnetic field wave travels along the metal conductors 21, 22. In the case of the simple slot antenna 10, the feed point 16 is across the slot 14. This forces the electromagnetic wave to travel across the slot 14. More specifically, the current travels around the slot 14 and the voltage across the slot 14. So, in the metal dipole antenna 20, the metal conductors 21, 22 form the radiating element, whereas in a slot antenna 10, the slot 14 is the radiating element. In FIGS. 1A and 1B, the arrows indicate the magnitude and direction of a standing wave created in each case. In both figures, the same patterns hold true: the closer to the feed point, the greater the magnitude of the created standing wave and the closer to the end of the element, the smaller the magnitude of the created standing wave. If the length of the slot 14 and of the metal conductor 22 is nominally λ/2, the two antennas resonate at a frequency f=v/λ, where v is the velocity of the electromagnetic wave. Therefore, the length of the slot 14 and of the metal conductor 22 set the resonant frequency (or nominal operating frequency), while the majority of the radiation comes from the region where the current flow is greatest.

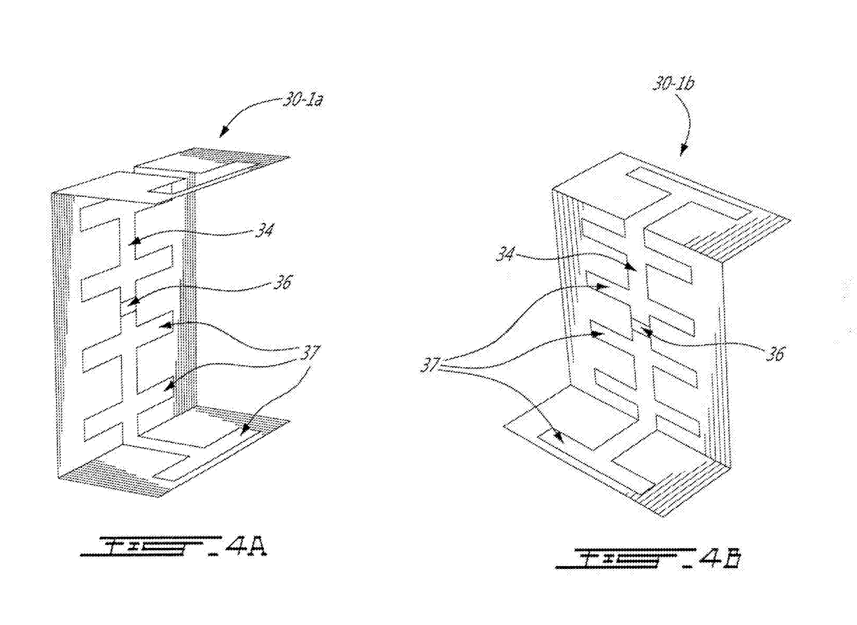

In view of the above, by bending lengthwise the ends of slot antennas 10 and 20, to arrive at slot antenna 10′ and metal dipole antenna 20′, as shown in FIGS. 2A and 2B, the desired frequency is maintained and only a small part of the radiation power is sacrificed. The radiating element in each case, namely slot 14′ for antenna 10′, and conductors 21′ and 22′ for antenna 20′, is still λ/2, so as to resonate at f=v/λ, but the change to the original pattern is very small because only the tips of the antennas 10 and 20 have been bent, and this only affects the smallest currents.

Slotted slot antennas that allow for a size reduction of the physical size of the antenna at a frequency of operation, compared to the physical size of a simple slot antenna at the same frequency of operation, are provided.

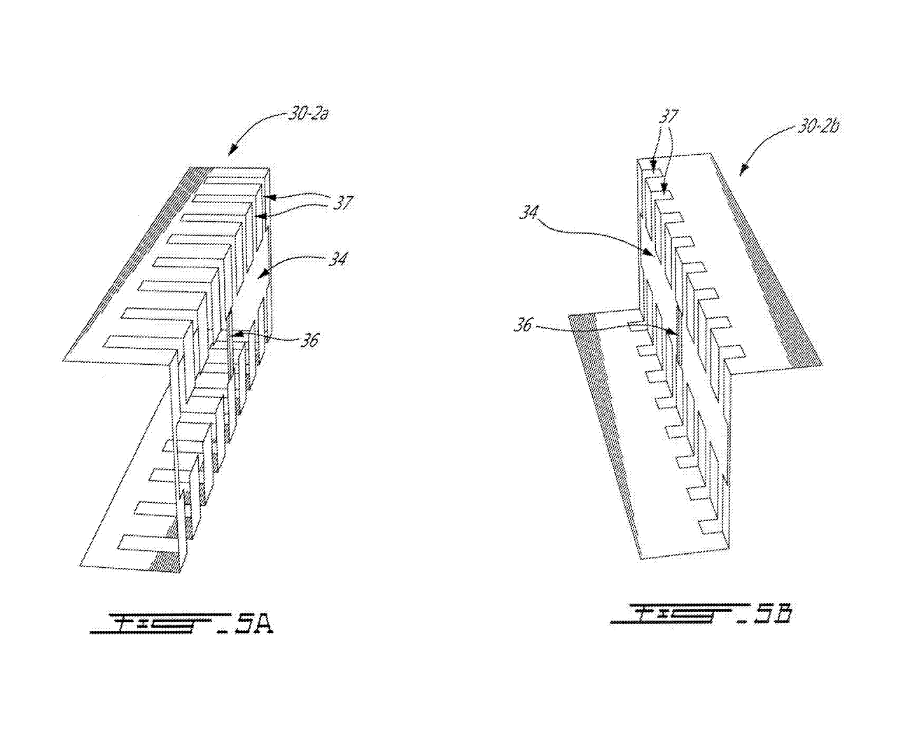

FIG. 3 illustrates a top view of a slot antenna 30 according to an embodiment of the present disclosure. Generally, slot antenna 30 may be used for transmitting or receiving frequencies within a bandwidth around a nominal operating frequency. Similarly to the simple slot antenna of FIG. 1A, slot antenna 30 comprises a conductor 32, a principal slot 34, and a feed point 36. However, in comparison to the simple slot antenna 10, the slot antenna 30 further comprises one or more side slots 37, also referred herein as secondary slots. The conductor 32 has an axis 33 defining a first conductor side 32-A and a second conductor side 32-B. The principal slot 34 extends longitudinally within the conductor along the axis 33. The feed point 36 (which may also be referred to as a feed port) comprises a first coupling point 36-A and a second coupling point 36-B respectively located on the first and second conductor sides, 32A, 32-B. The one or more side slots 37 extend from the principal slot 34, into conductor 32. Due to the presence of one or more side slots 37, slot antenna 30 and any equivalents are also further referred herein as ‘slotted slot antennas’ or ‘toothed antennas’.

In operation, feed point 36 allows coupling of an oscillating current to the slot antenna 30, via the two coupling points 36-A, 36B. In operation, the one or more secondary slots 37 provide inductive and/or capacitive loading of the electromagnetic wave, causing it to slow down as it travels along the principal slot 34. Accordingly, the velocity of the wave and, therefore, the frequency of resonance, are reduced. Thus, for radiating at the same frequency, the length of slot antenna 30 may be shorter than the length of the simple slot antenna 10 in FIG. 1A.

Various configurations of side slots 37 in terms of their overall number, shapes, locations relative to the principal slot 34, their respective lengths and widths, may be suitable. According to one embodiment, the length of all side slots 37 corresponds to a quarter wavelength of the nominal operating frequency, i.e. λ/4, and the width of all side slots corresponds to a tenth of the nominal operating frequency, i.e. λ/10. In other embodiments, the length of some or all of the side slots correspond to an integer multiple of the nominal operating frequency, i.e. nλ/4, where n is a positive odd integer. Various reduction factors for the length of the slot antenna 30 may thus be achieved with such configurations.

The side slots 37 may extend from the principal slot 34 into only one or into both conductor sides 32-A, 32-B. The side slots 37 may have simple elongated shapes, or they may be more complex slot shapes, such as fractal type shapes. The side slots 37 may have their own side slots.

FIG. 3 illustrates side slots 37 as perpendicularly oriented to the direction of of axis 33. However, other orientations may be possible. Such alternate orientations may be at angles other than 90° relative to the direction of the axis 33.

FIG. 3 also illustrates feed point 36 at half of the length of the principal slot 34. However, alternate feed point locations are possible, along the length of the primary or secondary slots. Also, alternate embodiments contemplate a plurality of feed points. These could be used, for example, in a balanced feed structure (or “push-pole”).

The ends (or tips) of the conductor 32 may be bent to further reduce the overall size of slot antenna 34. If either the principal slot 34 and the one or more of the side slots 37 bend with the bending of the end of the conductor, the radiating frequency is not affected.

The slotted slot antenna 30 may be realized as a vertically polarized or horizontally polarized antenna. The orientation of the principal slot 34 relative to the ground will indicate the type of polarization. Since, in operation, the electric field is established across the principal slot 34, if the principal slot is parallel to the ground, the slot antenna is vertically polarized. Likewise, if the principal slot is perpendicular to the ground, the slot antenna is horizontally polarized. Using a combination of slotted slot antennas 30 within a radio product may therefore provide polarization diversity, which is useful for MIMO operation. Furthermore, an electronic device comprising one or more slotted slot antennas 30 may achieve a well-defined vertical polarization, which is useful for ceiling mounting.

Low cost metal such as tin may be used as the conductor 32 material. This allows for ease of manufacture and decreases the overall cost of the product.

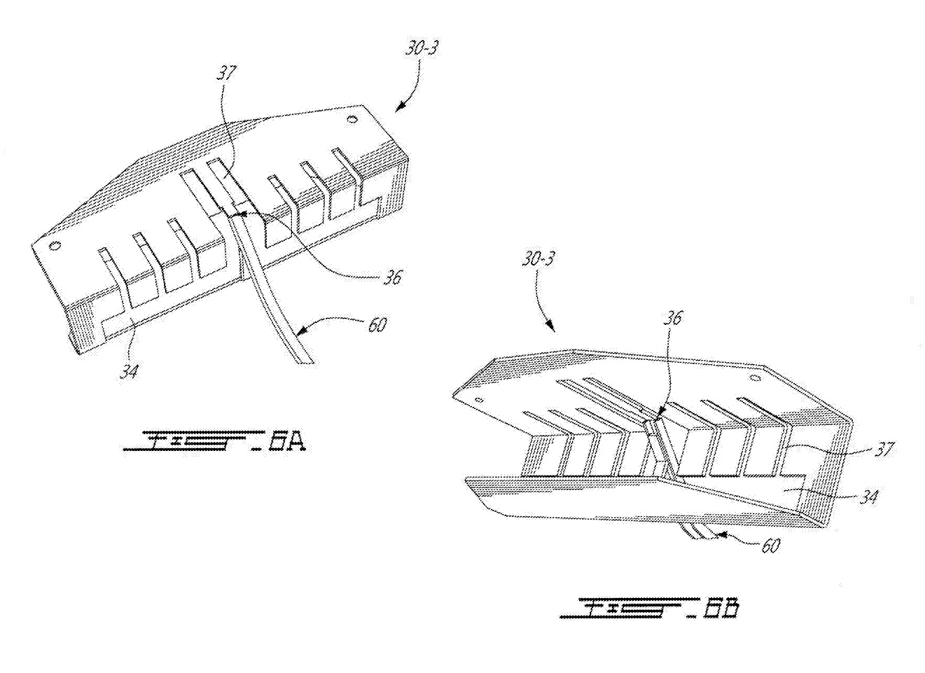

FIGS. 4A, 4B, 5A, 5B, 6A, 6B, 7 and 8 illustrate various variants of slotted slot antenna 30 according to the present disclosure. In these figures, similar numerals are used for similar elements. In particular, antennas 30-1a, 30-1b, 30-2a, 30-2b, 30-3, 30-4 and 30-5 are slotted slot antennas, comprising, each, one principal slot 34, one feed point 36 and a plurality of side slots 37. Various particular features of each of these embodiments may be combined in other embodiments.

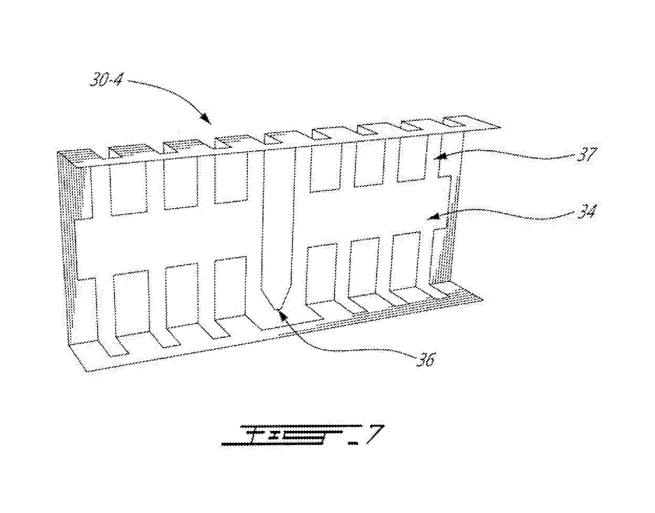

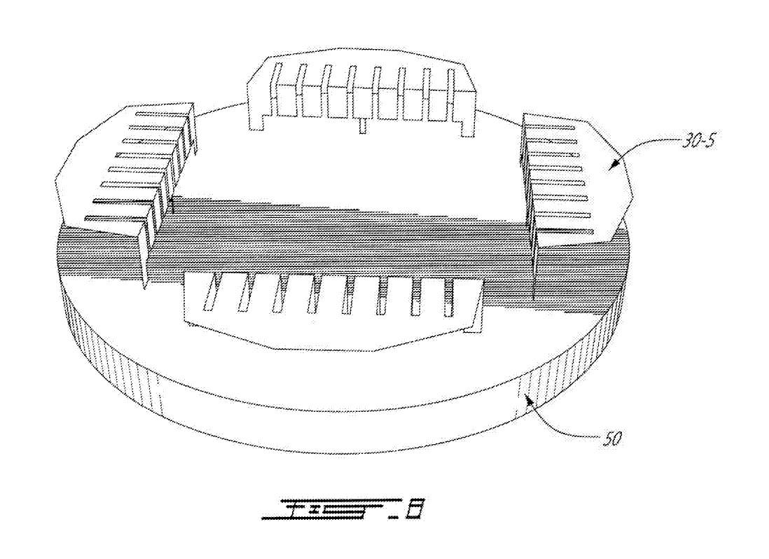

In some embodiments, the conductor 32 is bent to adapt the size of the antenna 30 to fit an available mounting space. In slotted slots antennas 30-1a and 30-1b of FIGS. 4A and 4B, the ends of the principal slot 34 are bent, by bending the conductor. This allows for a further length reduction of the respective slotted slot antennas. In slotted slots antennas 30-2a, 30-2b, 30-3 and 30-4 of FIGS. 5A, 5B, 6A, 6B and 7, the ends of the side slots 37 are bent, by bending the conductor. This allows for a width reduction of the respective slotted slot antennas. In some embodiments (not shown), the ends of the principal slot 34 are bent to reduce the length of the slot antenna and the ends of the one or more side slots 37 are bent to reduce the width of the slot antenna. According to disclosed embodiments, the bending of the ends of the principal slot 34 and side slots 37 allows for a reduction of the length and width of the antenna without sacrificing the gain of the antenna. The bending may be in the same direction (“U”-shaped), as in FIGS. 4A and 5A, in opposing directions (“Z”-shaped), as in FIGS. 4B, 5B, 6A and 6B or in just one direction (not shown). In alternate embodiments (not shown), bending may follow more complex geometries such as arcs or corners.

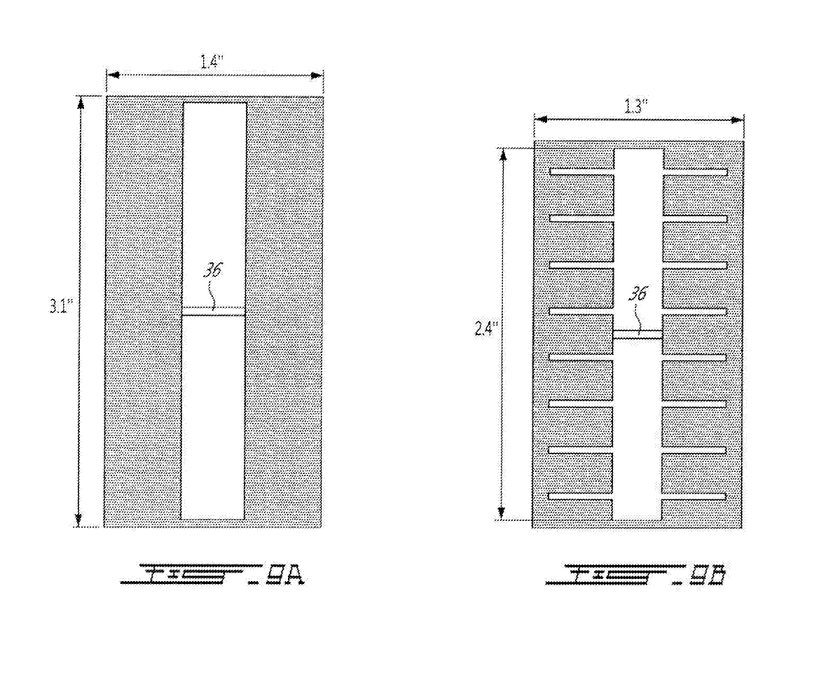

The side slots 37 may be located on both sides of the principal slot 34 as in FIGS. 4, 5 and 7 or on only one side of the principal slot 34, as in FIGS. 6A and 6B. The side slots 37 may have equal lengths and widths or they may have different lengths and widths, as seen in the drawings.

In the embodiment illustrated in FIGS. 6A-6B, conductor 32 is orthogonally bent to the plane of the principal slot 34. This feature allows for easy mounting of the slot antenna 30-4 side onto a flat mounting surface and, in particular, over a ground plane.

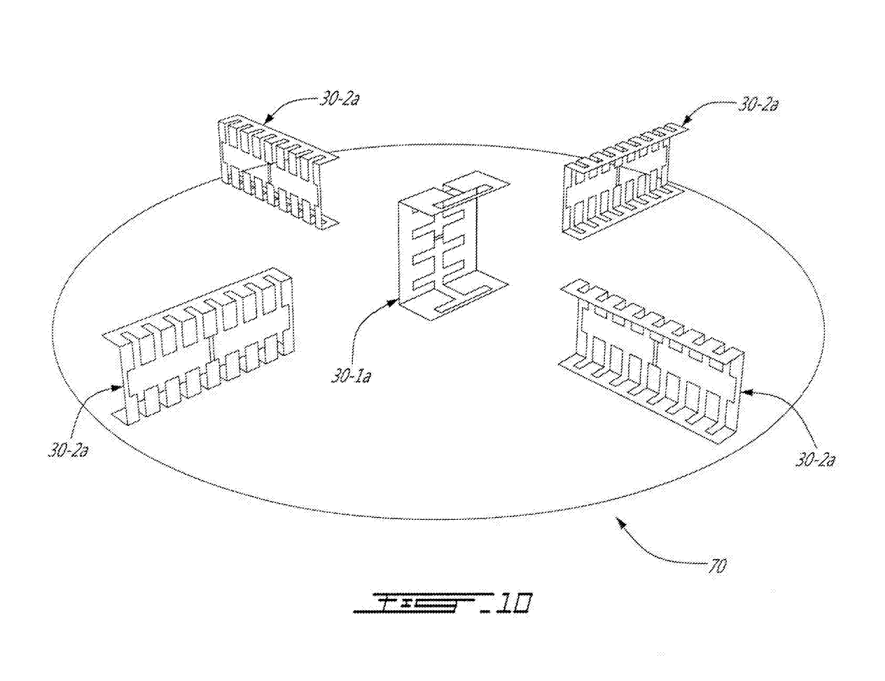

The feed point 36 may be located along the length of the primary slot 34 as in FIGS. 4-5, or along the length of side slots 37, as in FIGS. 6 and 7.

The feed point 36 may be adapted to connect to an RF cable. FIGS. 6A and 6B illustrate two perspective view of a slotted slot antenna 30-5 showing an RF cable 60 attached to the feed point 36. The feed point has a first and second coupling points on opposite sides of the conductor relative to the principal slot 34. The first coupling point is adapted to connect to the ground via coupling means such as a braided sheath within the RF cable 60. The second coupling point is adapted to connect to an RF signal via coupling means such as an alternating current (AC) pin in the RF cable 60.

FIG. 7 illustrates an embodiment of a slot antenna 30-4 according to the present disclosure in which the feed point 36 may be adapted to be directly connected to a mounting board, such as a printed circuit (PCB) board. Advantageously, this eliminates the need to use an RF cable. Accordingly, such embodiments may be more reliable and may cost less to implement.

A one half slotted slot antenna may be achieved from a half of a slotted slot antenna placed at an angle over a ground plane. The angle may be 90°. FIG. 8 illustrates four half slotted slot antenna 30-5 orthogonally placed over an uninterrupted ground plane 50. Each slotted slot antenna 30-5 may be obtained by cutting half of either slotted slot antenna 30-2a or 30-2b, along the length of the principal slot 34. It will be recognized that slotted slot antennas 30-5 may be directly machined as a half slotted slot antenna, rather than being cut from full slotted slot antennas.

In an alternate embodiment, not shown, a one half slotted slot antenna may be placed over a second slot in a ground plane at an angle, such as 90°. The second slot may also have side slots in the ground plane. The second slot may also, or alternatively, have its ends bent at right angles (orthogonal) in the plane of the ground plane.

Furthermore, in another embodiment, a one half slotted slot antenna comprises a plane conductor placed at an angle, such as 90°, over an elongated principal slot in a ground plane. The principal slot in the ground plane has side slots providing and inductive and/or capacitive loading.

In another contemplated slotted slot antenna embodiment, not shown, the conductor is adapted to partially slide within a ground plate.

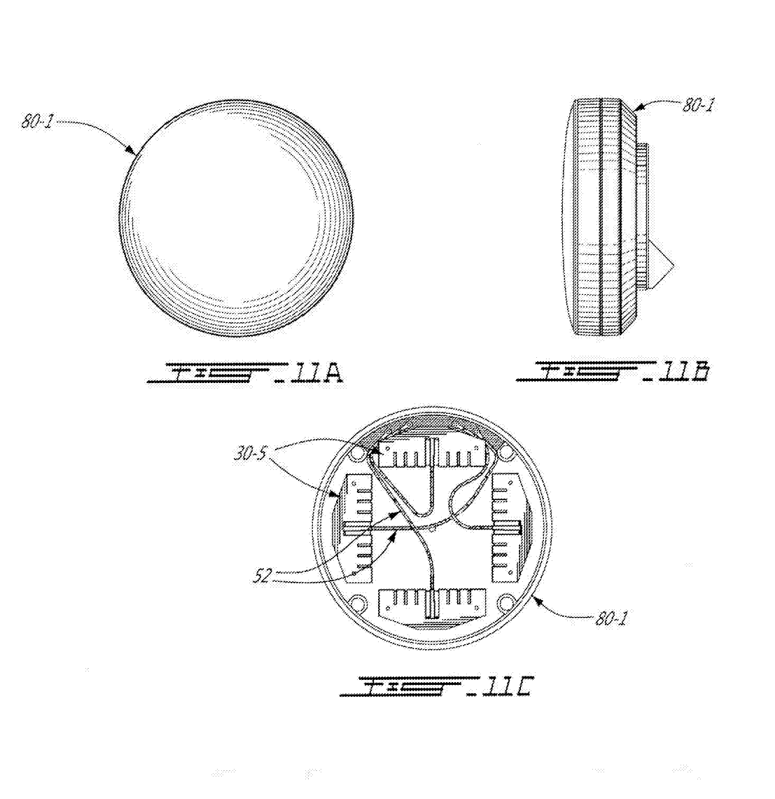

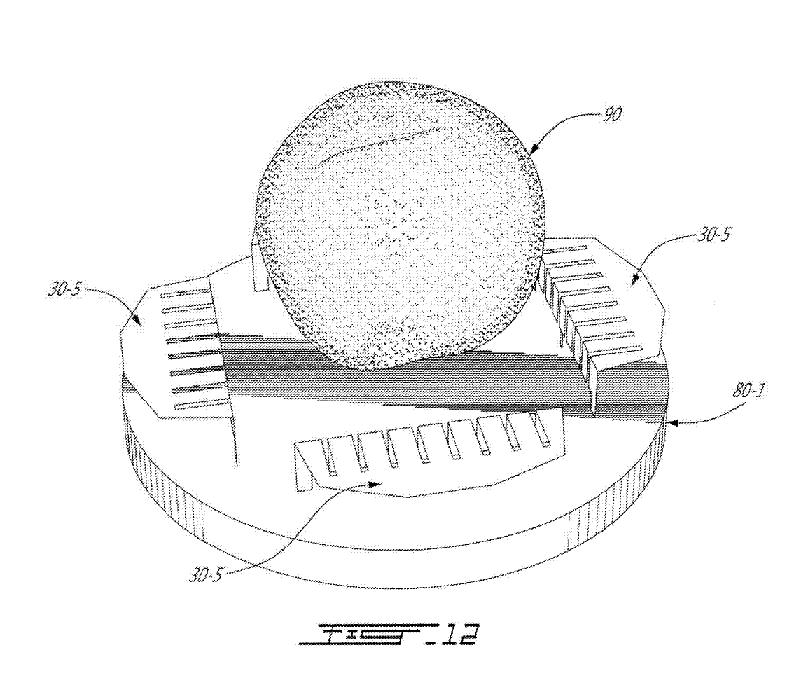

FIGS. 9A and 9B illustrates dimensions of one slotted slot antenna according to an embodiment of the present disclosure. FIG. 9A shows a diagram of a simple slot antenna for a given frequency as 1.4″ wide and 3.1″ long. FIG. 9B shows a slotted slot antenna for the same frequency as 1.3″ wide and ×2.4″ long. It can be seen that while antenna in FIG. 9B is not bent, for the same frequency, a length reduction factor of ˜0.77 (=2.4/3.1) is achieved only through the addition of side slots.

Products may be developed using one or more slotted slot antennas. FIGS. 10-19 pertain to electronic devices comprising one or more slotted slot antennas, according to embodiments of the present disclosure.

According to some embodiments, the plurality of slot antennas may be mounted symmetrically around a central axis orthogonal to the ground plane to allow, during operation of the antenna, a symmetrical far field distribution.

FIG. 10 illustrates an electronic device 70 combining multiple slotted slot antennas. In particular, assuming a ceiling mounting, four vertically polarized slotted slot antennas 30-2a are arranged around a horizontally polarized slotted slot antenna 30-1a. It will be understood that many other combinations or arrangements of elements are possible.

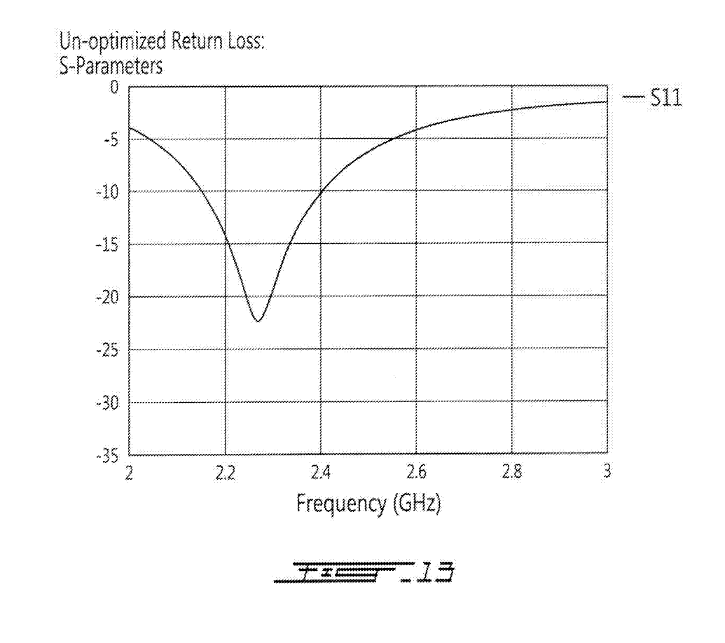

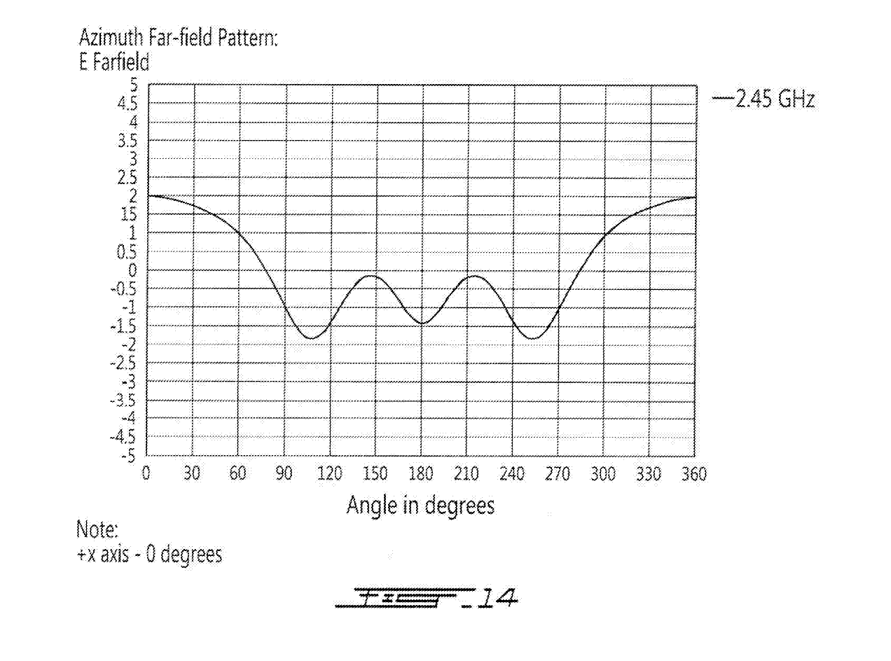

Slotted slot antennas according to some embodiments of the present disclosure are suitable for use in small form factor or ultra-compact Wi-Fi radios. FIGS. 11A-11C illustrates a Wi-Fi DOT radio 80-1 according to an embodiment of the present disclosure. This ultra-compact Wi-Fi radio employs four slotted slot vertically polarized antennas 30-5, fed by RF cables 52.

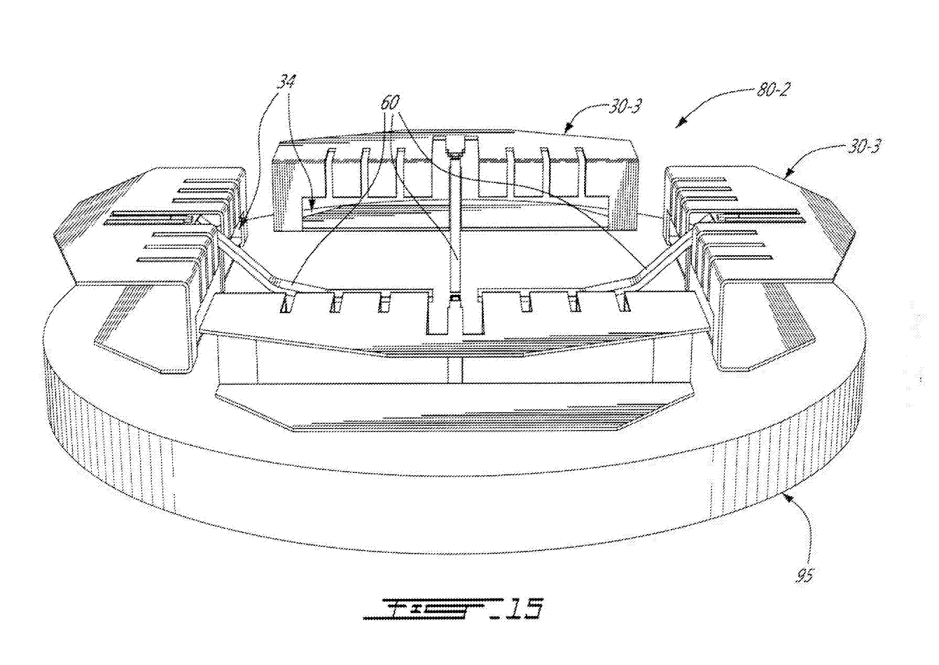

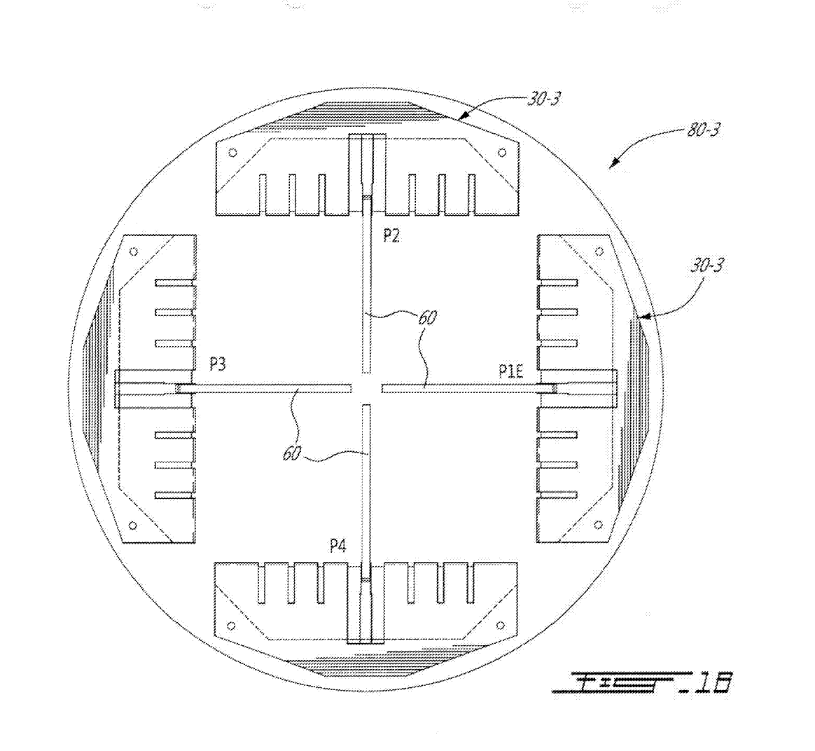

FIG. 12 is a rendering of the emission pattern 90 of the radio of FIGS. 11A-11C. FIG. 13 is a chart illustrating the un-optimized return loss. FIG. 14 is a chart illustrating the azimuth far-field pattern.

FIG. 15 illustrates an electronic device 80-2 according to another embodiment of the present disclosure. The electronic device comprises four slotted slot antennas 30-3 arranged over a circular uninterrupted ground plate 95 such that their principal slots 34 form a square. The four slotted slot antennas are connected to respective RF cables 60 via feed points.

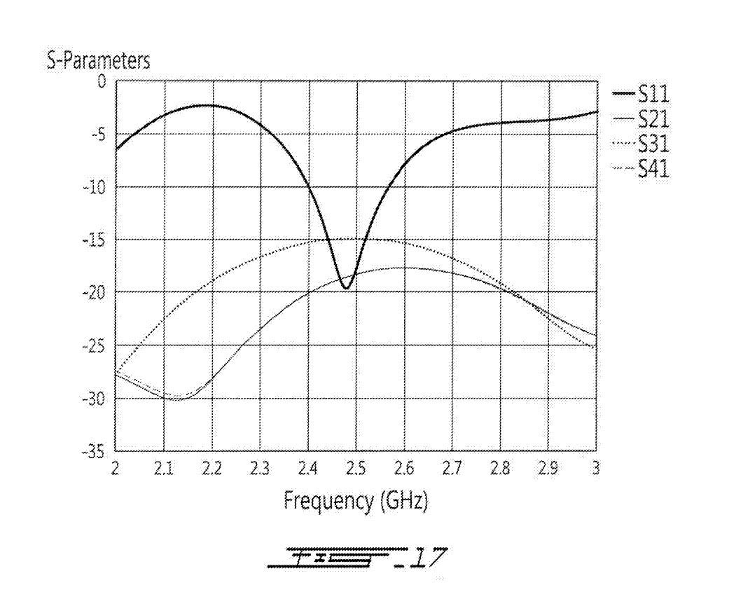

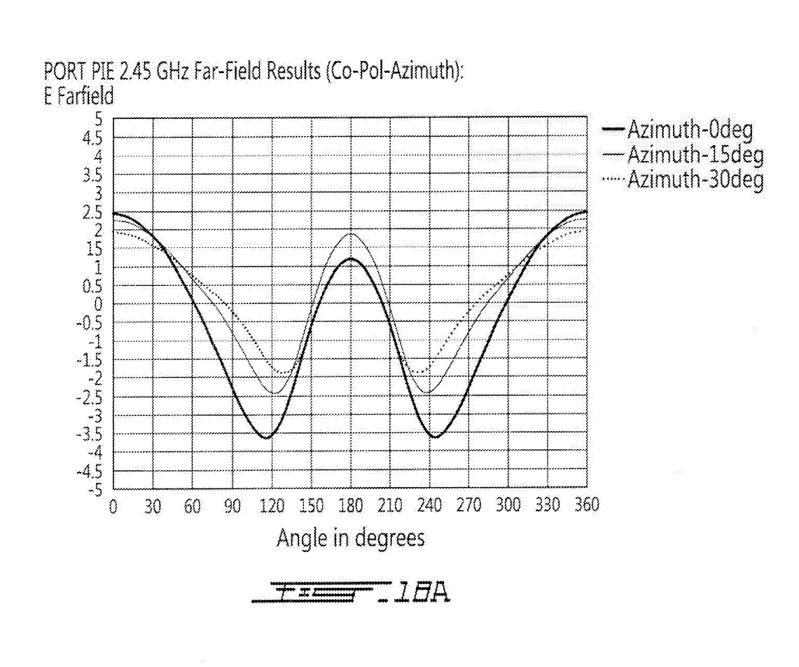

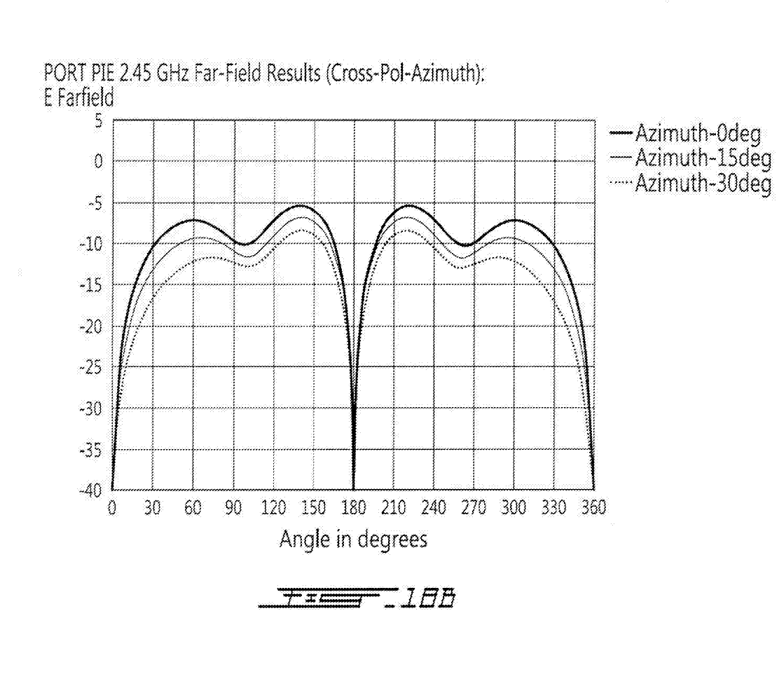

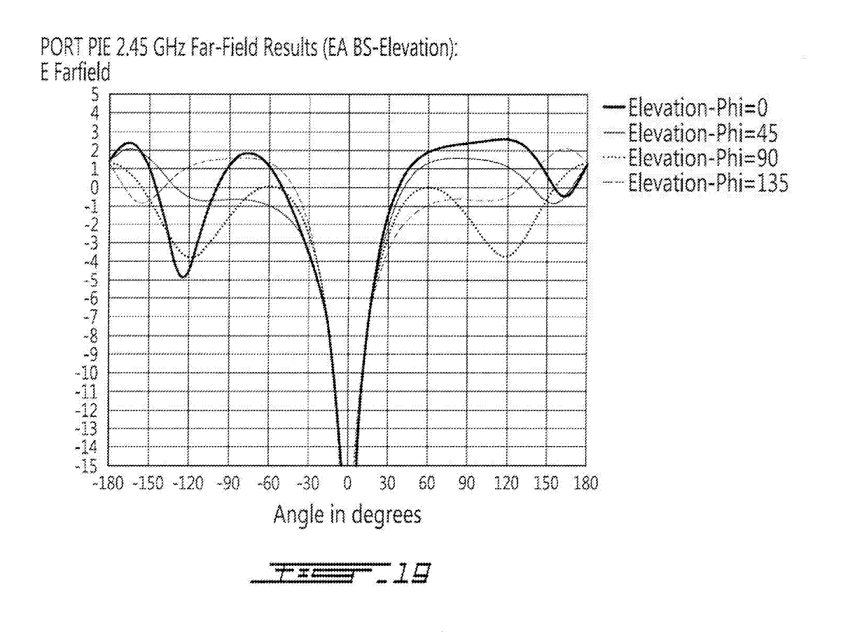

FIG. 16 illustrates a diagram of the device in FIG. 15 indicating the ports P1E, P2, P3 and P4 of the four slotted slot antennas 30-3 in device 80-2. Port P1E is the excitation port for simulation results shown in FIGS. 17, 18A and 18B and 19. With respect to the diagram in FIG. 16, orthogonal x, y z axes are defined as follows: The x-axis is pointing towards port P1E in the plane of the page, the y-axis is pointing towards port P2 in the plane of the page and the z-axis is pointing out of the plane of the paper. An Elevation angle Phi of 0 degrees (see FIG. 19) is along the x-axis. The value of the Elevation angle Phi is increasing in the x-y plane, going from the x axis towards the y axis, thus Elevation angle Phi=90 degrees is along the y axis. In FIGS. 18A and 18B, the azimuth of 0 degrees is along the horizon and the azimuths of 15 and 30 degrees are 15 and 30 degrees above the horizon, respectively.

FIG. 17 illustrates the s11 “return loss” parameter for a single antenna 30-3 in FIG. 15, with the vertical axis in dB. It can be observed that the antenna is adjusted for ˜2.5 GHz. The other parameters (s21, s31, s41) show antenna element-to-element isolation, which is in the range of −15 to −20 dB.

FIGS. 18A and 18B are charts illustrating the azimuth far-field patterns for vertical polarization and horizontal polarization, respectively, for a single antenna 30-3 in FIG. 15. Most of the radiated energy is in the vertical polarization and not in the horizontal polarization. Thus, the device 80-2 has a high vertical polarization, useful for ceiling mounting.

FIG. 19 shows the elevation pattern for a single antenna 30-3 in FIG. 15. 0 degrees along the abscissa is pointing straight up into the ceiling, and 180 degrees is pointing straight down. This antenna is an efficient radiator everywhere except straight up into the ceiling.

The slot antennas and electronic devices according to embodiments of the present disclosure may be adapted to either one of signal transmission, signal reception or signal transmission and reception.

Those skilled in the art will recognize improvements and modifications to the embodiments of the present disclosure. All such improvements and modifications are considered within the scope of the concepts disclosed herein and the claims that follow.

1. A slot antenna comprising:
a conductor having an axis defining a first and a second conductor sides;
a principal slot that extends longitudinally within the conductor along the axis;
a feed point having a first and a second coupling points respectively located on the first and second conductor sides; and
at least one side slot that extends from the principal slot.

2. The slot antenna of claim 1, wherein the at least one side slot extends from the principal slot into one of the first conductor side and the second conductor side.

3. The slot antenna of claim 1, wherein the at least one side slot extends from the principal slot into both the first conductor side and the second conductor side.

4. The slot antenna of claim 1, wherein the ends of the principal slot are bent to reduce the length of the slot antenna.

5. The slot antenna of claim 1, wherein the ends of the at least one side slot are bent to reduce the width of the slot antenna.

6. The slot antenna of claim 1, wherein the ends of the principal slot are bent to reduce the length of the slot antenna and the ends of the at least one side slot are bent to reduce the width of the slot antenna.

7. The slot antenna of claim 5, wherein the ends of the at least one side slot are bent in a U-shaped pattern.

8. The slot antenna of claim 5, wherein the ends of the at least one side slot are bent in a Z-shaped pattern.

9. The slot antenna of claim 1, wherein the conductor is bent to adapt the size of the antenna to fit an available mounting space.

10. The slot antenna of claim 1, wherein the side slots have fractal shapes.

11. The slot antenna of claim 1, wherein the feed point is configured to be directly attached to a printed circuit board (PCB).

12. An electronic device comprising:
a ground plane; and
a slot antenna mounted on the ground plane, the slot antenna comprising:
a conductor having an axis defining first and a second conductor sides;
a principal slot that extends longitudinally within the conductor along the axis;
a feed point having a first and a second coupling points respectively located on the first and second conductor sides; and
at least one side clots slot that extends from the principal slot.

13. The electronic device of claim 12, wherein the principal slot of the slot antenna is parallel to the ground plane.

14. The electronic device of claim 12, wherein the principal slot of the slot antenna is perpendicular to the ground plane.

15. An electronic device comprising:
a ground plane; and
a plurality of slot antennas mounted on the ground plane, each slot antenna comprising:
a conductor having an axis defining first and a second conductor sides;
a principal slot that extends longitudinally within the conductor along the axis;
a feed point having a first and a second coupling points respectively located on the first and second conductor sides; and
at least one side slot that extends from the principal slot.

16. The electronic device of claim 15, wherein a first set of the plurality of slot antennas have their principal slot parallel to the ground plane and the remaining slot antennas have their principal slot horizontal to the ground plane.

17. The electronic device of claim 15, wherein the plurality of slot antennas are mounted symmetrically around a central axis orthogonal to the ground plane to allow, during operation of the antenna, a symmetrical far field distribution.

18. The slot antenna of claim 1, configured for at least one of signal transmission and signal reception.
